(19) United States
(12) Patent Application Publication
(10) Pub. No.: US 2013/0302657 A1
(43) Pub. Date: Nov. 14, 2013

(54) STORAGE BATTERY SYSTEM AND METHOD OF RE-CONFIGURING A CONNECTION

(71) Applicant: Akihiro ITAKURA, Kanagawa-ken (JP)

(72) Inventor: Akihiro ITAKURA, Kanagawa-ken (JP)

(21) Appl. No.: 13/718,195

(22) Filed: Dec. 18, 2012

(30) Foreign Application Priority Data
May 11, 2012 (JP) 2012-110104

(51) Int. Cl. H01M 10/44

(52) U.S. Cl. CPC H01M 10/441
USPC 429/61

(57) ABSTRACT

A storage battery system, includes a determining unit that compares a degraded state of a plurality of battery cells estimated by an estimating unit with a first predetermined degraded state to determine whether to exchange the battery cell; a calculating unit that calculates an evaluation value to evaluate a health state of a plurality of battery-cell arrays based on a degraded state of the plurality battery cells; and a control unit that controls a first connection unit connected to a degraded battery cell which is determined that exchange is needed, so as to exchange the degraded battery cell with a battery cell different from the degraded battery cell in a direction where an evaluation value becomes equal to or larger than a predetermined threshold.

### CROSS-REFERENCE TO RELATED APPLICATIONS

This application is based upon and claims the benefit of priority from prior Japanese Patent Application No. 2012-110104, filed May 11, 2012, the entire contents of which are incorporated herein by reference.

### FIELD

Embodiments disclosed herein relate to a storage battery system and a method of changing a connection configuration.

### BACKGROUND

A role of a storage battery, such as stabilization of a power system and renewable energy including photovoltaic power generation (PV) or the like, an electric vehicle (EV) becomes very important. In order to cope with these various usage situations, a storage battery system that is formed by connecting a plurality of battery cells (hereinafter, referred to as cells) is provided. There is a strong demand for the storage battery system which can be used with safety and reliability and is hardly degraded.

In the storage battery system including a plurality of cells, a status of degradation of each cell changes by repeating charging and discharging due to individual differences of cells. In the storage battery system, when a cell is degraded, the capacity of a normal cell needs to be matched with that of the degraded cell, when charging in order to prevent the cell from becoming overcharged. Therefore, after allowing the capacity of the storage battery system to be degraded to some extent, the lifespan of the storage battery system is maintained. On the other hand, when charging is carried out to be matched the capacity of a normal cell after first maintaining the capacity of the storage battery system, a period up to when a cell reaches the end of its lifespan becomes short because the degraded cell is further degraded. As a result, the entire storage battery system reaches the end of its lifespan earlier.

The above mentioned technology is disclosed in Japanese Patent Application Publication No. 2009-213248, and contents of which are hereby incorporated by reference.

### BRIEF DESCRIPTION OF THE DRAWINGS

FIG. 1 is a diagram illustrating a storage battery system according to a first embodiment.

FIGS. 2A and 2B are diagrams illustrating a selector according to the first embodiment.

FIG. 3 is a diagram illustrating a BMS according to the first embodiment.

FIG. 4 is a flowchart illustrating a method of re-configuring a connection of battery cells according to the first embodiment.

FIGS. 5A and 5B are diagrams illustrating an example of re-configuring the connection of battery cells according to the first embodiment.

FIG. 6 is a diagram illustrating a storage battery system according to a second embodiment.

FIG. 7 is a flowchart illustrating a method of re-configuring a connection of battery cells according to the second embodiment.

FIGS. 8A and 8B are diagrams illustrating an example of re-configuring the connection of battery cells according to the second embodiment.

### DETAILED DESCRIPTION

According to one aspect of embodiments, it is provided that a storage battery system, includes a group of battery cells that includes a plurality of battery-cell arrays in which a plurality of battery cells are serially connected to each other, and the plurality of battery-cell arrays are connected to each other in parallel; a first connection unit that exchangeably connects different battery cells that are included in the different battery-cell array of the group of battery cells; an estimating unit that estimates a degraded state of the plurality of battery cells; a determining unit that compares the degraded state of the plurality of battery cells estimated by the estimating unit with a first predetermined degraded state, to determine whether to exchange the battery cell; a calculating unit that calculates an evaluation value to evaluate a health state of the plurality of battery-cell arrays based on the degraded state of the plurality of battery cells estimated by the estimating unit; and a control unit that controls the first connection unit connected to a degraded battery cell which is determined that exchange is needed by the determining unit, so as to exchange the degraded battery cell with a battery cell different from the degraded battery cell in a direction where the evaluation value becomes equal to or larger than a predetermined threshold.

According to another aspect of embodiments, it is provided that a method of re-configuring a connection in a storage battery system including a group of battery cells that includes a battery-cell array where a plurality of battery cells are serially connected to each other and in which a plurality of the battery-cell arrays are connected to each other in parallel, and a first connection unit that exchangeably connects different battery cells that are included in the different battery-cell array in the group of battery cells, the method includes estimating, by an estimating unit, a degraded state of the battery cells; comparing, by a determining unit, the degraded state of the battery cell estimated by the estimating unit with a first predetermined degraded state to determine whether to exchange the battery cell; calculating, by a calculating unit, an evaluation value to evaluate a health state of the battery-cell array based on the degraded state of the battery cell estimated by the estimating unit; and controlling, by a control unit, the first connection unit connected to the degraded battery cell where the determining unit determines that the exchange is needed in a direction where the evaluation value becomes equal to or larger than a predetermined threshold so as to exchange the degraded battery cell with a battery cell different from the degraded battery cell.

According to an embodiment, a storage battery system and a method of re-configuring a connection that suppress the capacity degradation of the storage battery system and enable the storage battery system to have a long lifespan can be provided.

Hereinafter, embodiments will be described in detail with reference to the drawings.

### First Embodiment

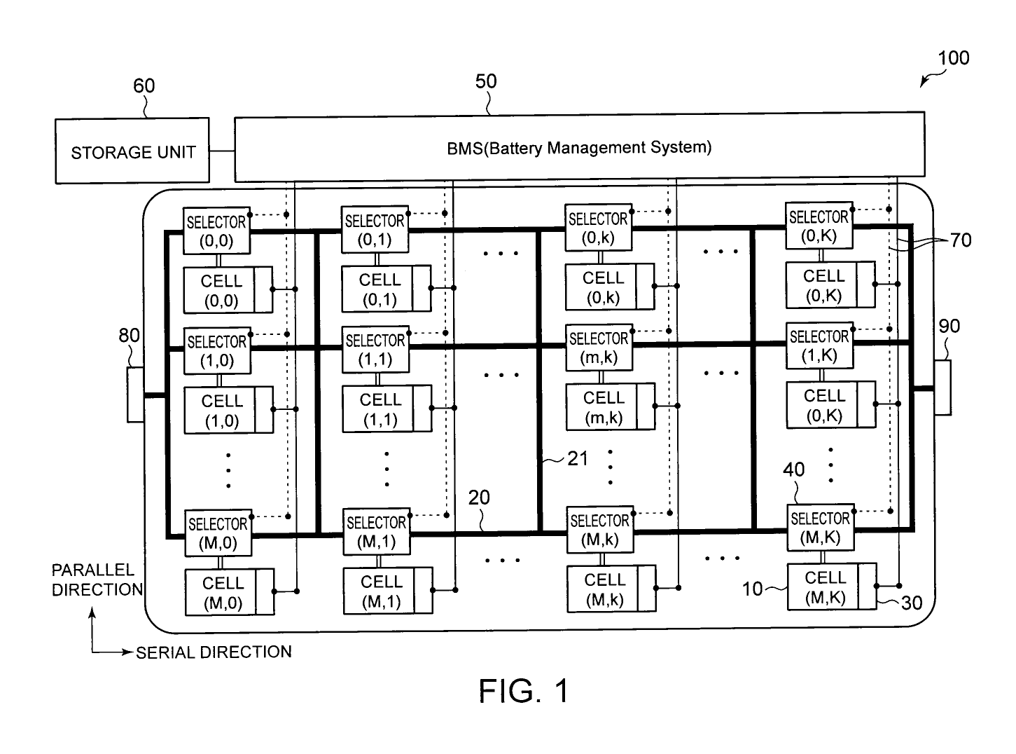

FIG. 1 is a diagram illustrating a storage battery system 100 according to a first embodiment.

The storage battery system 100 includes a plurality of battery cells 10, a bus line 20 that connects the battery cells 10 in series and in parallel, a first connection unit 21 that exchangeably connects the battery cells 10, a monitoring circuit 30 that monitors the state of each battery cell 10, a battery management system (BMS) that controls the first connection unit 21 and the monitoring circuit 30, and a storage unit 60. In this embodiment, the first connection unit 21 includes selectors 40 that are connected to each battery cell 10. In addition, an arithmetic processing device including a CPU or the like is used as the BMS 50. A storage device including a memory or the like is used as the storage unit 60.

The battery cells 10 form a battery-cell array serially connected by the bus line 20 through the selector 40. Further, a plurality of battery-cell arrays is connected in parallel by the bus line 20 through the selector 40 to form a group of battery cells. Also, the plurality of battery cells 10 are exchangeably connected by the first connection unit 21. In addition, the embodiment describes an example where the first connection unit 21 connects the plurality of battery cells 10 in parallel that are arranged in the same column. However, the first connection unit 21 is not limited to the connections in the same column but may connect battery cells 10 to the plurality of battery cells 10 excluding the battery cells 10 that are arranged in the same row.

As illustrated in FIG. 1, an example is described in which (M+1)×(K+1) battery cells 10 with M+1 rows in a parallel direction and K+1 columns in a serial direction are connected to each other. In addition, the battery cell 10 that is located in the m-th row and the k-th column is hereinafter denoted by a battery cell (m, k).

Here, a plurality of battery cells (m, 0) to (m, K) located in the same m-th row is serially connected by the bus line 20 and forms the battery-cell array m of the m-th row. Further, the battery-cell arrays are connected in parallel by the bus lines 20. Also, a plurality of battery cells (0, k) to (M, k) located in the same k-th column are connected in parallel by the first connection unit 21.

The selectors 40 have a one-to-one connection to the battery cells 10 and re-configure the connection of battery cells 10. Each selector 40 is connected to the BMS 50 by a communication line 70 and changes the connection configuration of each battery cell 10 based on an instruction from the BMS 50. In addition, hereinafter, the selector 40 connected to the battery cell (m, k) is denoted by a selector (m, k).

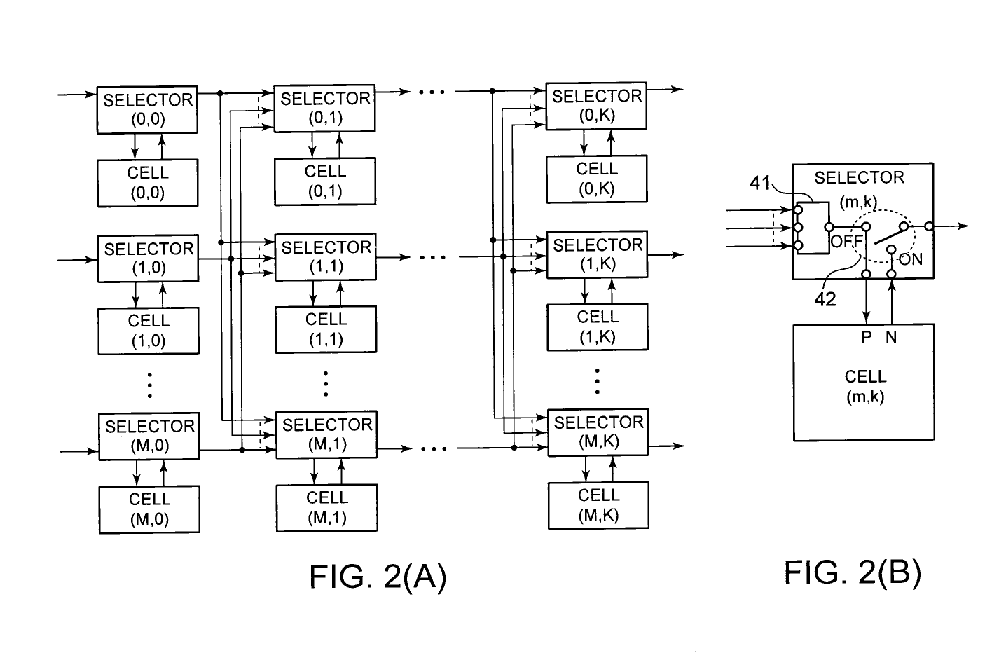

FIGS. 2A and 2B are diagrams illustrating a configuration of the selectors 40 according to the first embodiment. FIG. 2A illustrates connection relations between the battery cells 10 and the selectors 40 and between the selectors 40. FIG. 2B illustrates the internal configuration of the selector 40.

At each selector (m, k), its input and output sides are respectively connected to a selector (m, k−1) in the preceding column and to a selector (m, k+1) in the following column, by the bus line (20). In addition, at a selector (m, 0), its input and output sides are respectively connected to an input terminal 80 and to a selector (m, 1) in the following column. At a selector (m, K), its input side and its output side are respectively connected to the selector (m, k−1) in the preceding column and to an output terminal 90.

Also, each selector (m, k) includes an internal selector 41 and a switch 42.

The internal selector 41 receives a control signal from the BMS 50 through the communication line 70 and selects one of selectors (m, k−1) connected to the input side of the selector (m, k) based on the control signal. Then, the battery output from the battery cell (m, k−1) connected to the selected selector (m, k−1) is received as an input.

The switch 42 switches the connection/disconnection of the battery output from the battery cell (m, k) connected to the selector (m, k). When being connected (the switch 42 is in an ON state), a battery output that is serial with the battery output of the battery cell (m, k−1) in the preceding column is output from the selector (m, k). When being disconnected (the switch 42 is in an OFF state), the battery cell (m, k) is disconnected and the battery output of the battery cell (m, k−1) in the preceding column is output from the selector (m, k) as it is.

In addition, the input side of the selector (m, 0) is connected to the input terminal 80 and the selector (m, 0) may thus have only the switch 42 without the internal selector 41.

The monitoring circuit 30 is connected to each battery cell 10 to monitor physical amounts, that is, the state of a voltage, a temperature or the like that may affect the capacity degradation of the connected battery cell 10 and to transmit the state (monitored data signals) to the BMS 50 through the communication line 70.

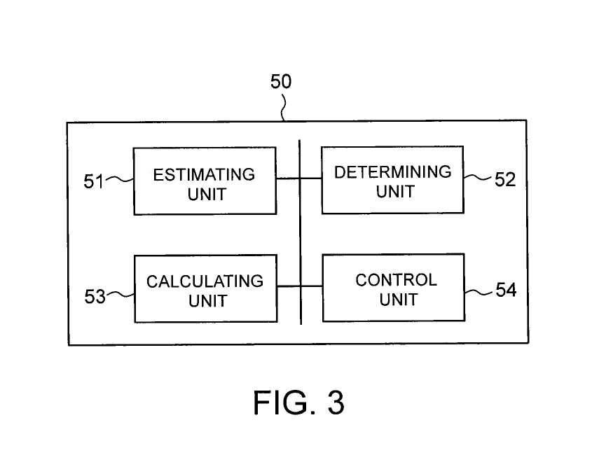

FIG. 3 is a diagram illustrating the BMS 50 according to the first embodiment.

The BMS 50 includes an estimating unit 51 that estimates the degraded state of the battery cell 10, a determining unit 52 that determines whether to exchange the battery cell 10, a calculating unit 53 that calculates an evaluation value to evaluate the health state of the battery-cell array, and a control unit 54 that controls the first connection unit 21 including the selector 40.

The estimating unit 51 obtains the monitored data signals from the monitoring circuit 30 of each battery cell and estimates the degraded state such as capacity degradation of each battery cell 10 based on the monitored data signals. In this embodiment, an SOH (State Of Health) is used as an indicator of the degraded state.

The determining unit 52 determines whether to exchange each battery cell 10 based on the degraded state of each battery cell 10 that is estimated by the estimating unit 51. A range of degradation where each battery cell 10 can be still used is predetermined. Specifically, using the SOH as a reference, a lower-bound threshold (a first reference value) in a normal range, for example, and an upper-bound threshold (a second reference value) in a degradation range lower than the first reference value are predetermined. In addition, the first reference value and the second reference value are stored in a storage unit 60.

When the SOH of each battery cell 10 is larger than the first reference value, for example, the determining unit 52 determines the battery cell 10 as being normal. When the SOH of each battery cell 10 is smaller than or equal to the first reference value and larger than the second reference value, for example, the determining unit determines the battery cell 10 as being degraded (necessary to exchange). Also, when it is smaller than or equal to the second reference value, the determining unit 52 determines that the battery cell 10 has a lifespan where degradation progresses to an extent that the battery cell 10 can no longer be used.

The calculating unit 53 calculates an evaluation value for each battery-cell array to evaluate the health state of the battery-cell array based on the degraded state of each battery cell 10 estimated by the estimating unit 51. It can be said that the health state is healthy when the evaluation value is equal to or larger than a predetermined threshold and unhealthy when the evaluation value is smaller than the predetermined threshold. In this embodiment, the sum of the SOHs of battery cells 10 included in each battery-cell array is used as the health state.

When the determining unit 52 determines the battery cell 10 as being degraded, the control unit 54 controls the internal selector 41 and the switch 42 of each selector 40 so that the evaluation value of each battery-cell array calculated by the calculating unit 53 becomes equal to or larger than the predetermined threshold. Specifically, the control unit 54 generates a control signal to control the internal selector 41 and the switch 42 and transmits the control signal to each selector 40 through the communication line 70.

Here, in order for the evaluation value of each battery-cell array to become equal to or larger than the predetermined threshold, the control unit 54 generates a control signal to re-configure the connection of battery cells 10 so that the battery cell (the degraded battery cell) 10 which the determining unit 52 has determined as being degraded is exchanged with a battery cell 10, which is included in the different battery-cell array and is located at the same column. In addition, in this embodiment, the control unit 54 controls the switch 42 so that it is always in an ON state.

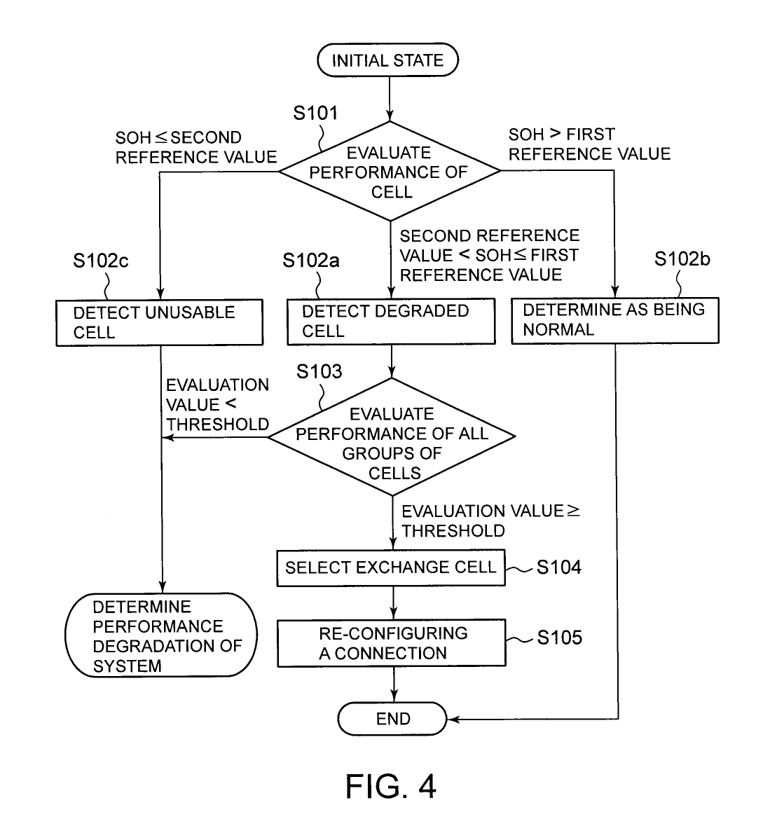

Hereinafter, a method of changing the connection configuration will be described with reference to FIG. 4.

In step S101, the estimating unit 51 obtains the monitored data signals from the monitoring circuit 30, estimates the SOH as the degraded state of battery cells 10, and evaluates the performance of all the battery cells 10.

In steps S102a to S102c, the determining unit 52 compares the SOH of battery cells 10 estimated in step S101 with the first reference value and the second reference value of the SOH, which are predetermined, and determines the state of battery cells 10. When the battery cell 10 of which the SOH is smaller than or equal to the first reference value and larger than the second reference value is present, it is determined that the battery cell 10 has been degraded and the degraded battery cell 10 is detected in step S102a.

In addition, when the SOH of all the battery cells 10 is larger than the first reference value, the determining unit 52 determines that all the battery cells 10 are normal, in step S102b and the flows end. On the other hand, when the battery cell 10 of which the SOH is smaller than or equal to the second reference value is present, it is determined that the battery cell 10 has reached the end of its lifespan and the unusable battery cell 10 is detected in step S102c. At this time, it is determined that the performance of the storage battery system 100 has been degraded and the flows end.

When the battery cell 10 that has been determined as being degraded is present in step S102a, the calculating unit 53 calculates the evaluation values of the battery-cell array as the sum of the SOH and evaluates the performance of all battery-cell arrays, in step S103.

When the connection of battery cells 10 in which the evaluation values of all battery-cell arrays calculated in step S103 are equal to or larger than the threshold is present, the control unit 54 selects a battery cell 10 to be exchanged with the battery cell 10 that has been determined as being degraded in step S102a, from the same column, in step S104. Also, the control unit 54 controls the selector 40 so as to exchange the degraded battery cell with the selected battery cell 10 and changes the connection configuration of battery cells 10, in step S105. Subsequently, the flows end.

In addition, when the connection of battery cells 10 where the evaluation values of all battery-cell arrays calculated in step S103 are equal to or larger than the threshold is not present, it is determined that the performance of the storage battery system 100 is degraded and the flows end.

Also, in step S104, when a plurality of the connection of battery cells 10 where the evaluation values of all battery-cell arrays calculated in step S103 are equal to or larger than the threshold are present, the battery cell 10 that has been determined as being degraded and a battery cell 10 are selected so that, for example, the difference between the smallest of the evaluation values of all battery-cell arrays and the threshold is minimized.

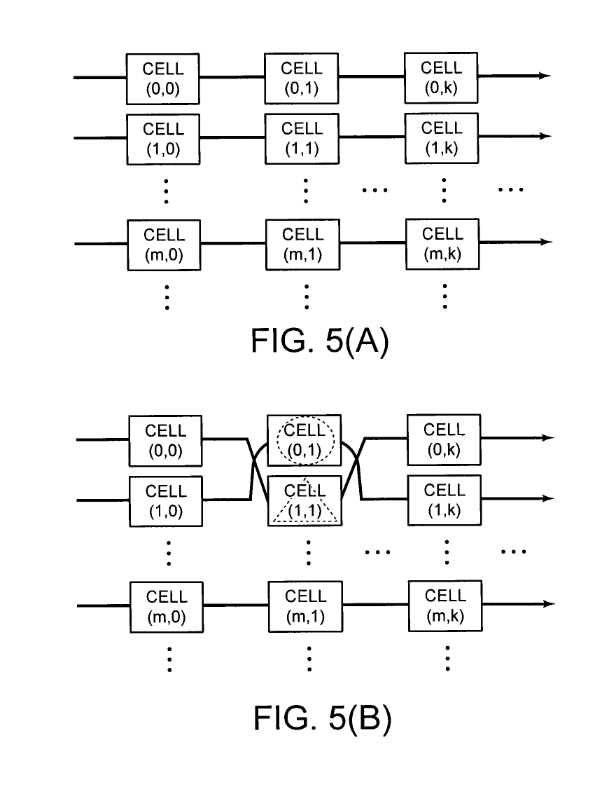

An example where the connection of battery cells has been re-configured will be described with reference to FIGS. 5A and 5B.

FIG. 5A is in an initial normal state and battery cells 10 are serially connected to each other. Also, FIG. 5B is in a state after the connection of battery cells 10 has been changed. At this time, the battery cell 10 represented by the mark Δ is a degraded cell that has been determined as being in a degraded state. The battery cell 10 represented by the mark ◯ is selected as an exchange cell and the connection of battery cells 10 is changed to replace the degraded cell with the exchange cell.

In addition, in this embodiment, when comparing the degraded state with the first reference and the second reference, or the evaluation value with the threshold, the terms “equal to or larger than”, “equal to or smaller than”, “larger than”, and “smaller than” are used. However, the terms are only examples and various terms may be used depending on how to take the first reference, the second reference, and the threshold. That is, other terms for replacing the terms “equal to or larger than” and “larger than” and other terms for replacing the terms “smaller than or equal to” and “smaller than” are possible to use.

Also, although the SOH has been used as the indicator of the degraded state, any indicators, such as internal resistance or the like that represent the degraded state of battery cells 10 may be used. Also, although the sum of the SOH has been used as the evaluation value, the mean value, the standard deviation or the like of the SOH may be used.

According to the storage battery system 100 of this embodiment, the capacity degradation of the storage battery system is suppressed and its lifespan can become long. That is, even when a specific battery cell has been degraded, it is possible to suppress the capacity degradation of the entire storage battery system 100 at a minimum by exchanging the degraded battery cell with another battery cell and it is possible to maintain the lifespan of the storage battery system 100 by suppressing the degradation of battery cells.

### Second Embodiment

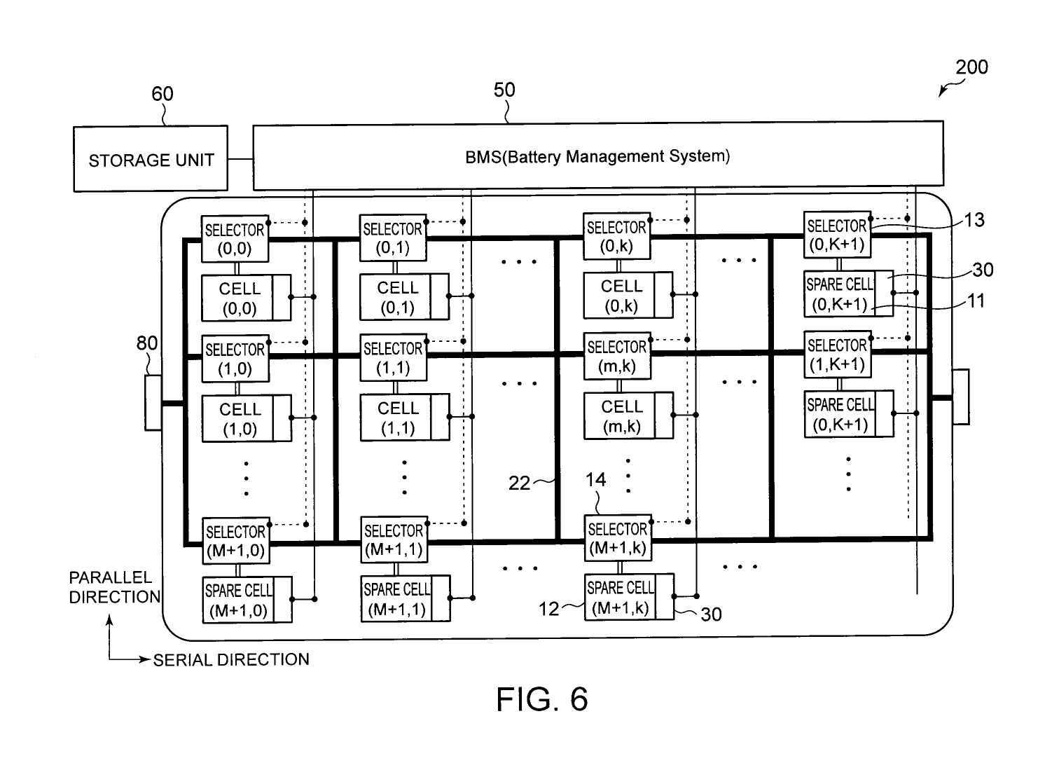

FIG. 6 is a diagram illustrating a storage battery system 200 according to a second embodiment.

In the storage battery system 200 of FIG. 6, the degradation of battery cells 10 entirely progresses. The storage battery system 200 is different from the storage battery system 100 of FIG. 1 in that a spare battery cell is further included to be used when a battery-cell array that withstands the exchange of the degraded battery cell 10 is not present. In addition, reference numerals of the similar to the storage battery system 100 are not denoted.

The spare battery cell includes a first spare battery cell (a serial spare battery cell) 11 and a second spare battery cell (a parallel spare battery cell) 12. The first spare battery cell 11 is one-to-one connected to a first selector (a serial selector) 13. Also, the second spare battery cell 12 is one-to-one connected to a second selector (a parallel selector) 14. Each spare battery cell is connected to each battery cell by a second connection unit 22. In this embodiment, the second connection unit 22 includes the first selector 13 and the second selector 14.

The serial spare battery cells 11 are serially connected to the battery-cell arrays m by the second connection units 22. More specifically, the serial spare battery cell 11 is connected to the (K+1)-th column adjacent to the battery cell (m, K) of each battery-cell array m. At this time, the serial spare battery cell 11 connected to each battery-cell array m is denoted by a serial spare battery cell (m, K+1). That is, the serial spare battery cells 11 include serial spare battery cells (0, K+1) to (M, K+1).

The parallel spare battery cells 12 are connected to battery-cell arrays 0 to M by the second connection units in parallel. More specifically, the parallel spare battery cell 12 is connected to the (M+1)-th row adjacent to the battery cell (M, k) of each battery-cell array. At this time, the parallel spare battery cell 12 connected to the battery cell (M, k) in the k-th row is denoted by a parallel spare battery cell (M+1, k). That is, the parallel spare battery cells 12 include parallel spare battery cells (M+1, 0) to (m+1, K).

The serial selectors 13 and the parallel selectors 14 respectively include internal selectors 41 and switches 42, similarly to the selectors 40. The serial selector 13 connected to the serial spare battery cell (m, K+1) is denoted by a serial selector (m, K+1). Also, the parallel selector 14 connected to the parallel spare battery cell (M+1, k) is denoted by a parallel selector (M+1, k).

The monitoring circuit 30 is connected to each serial spare battery cell 11 and each parallel spare battery cell 12 to monitor the voltage, temperature or the like of the connected serial spare battery cell 11 and the connected parallel spare battery cell 12 and to transmit the state (a monitoring data signal) to a BMS 50 through a communication line 70.

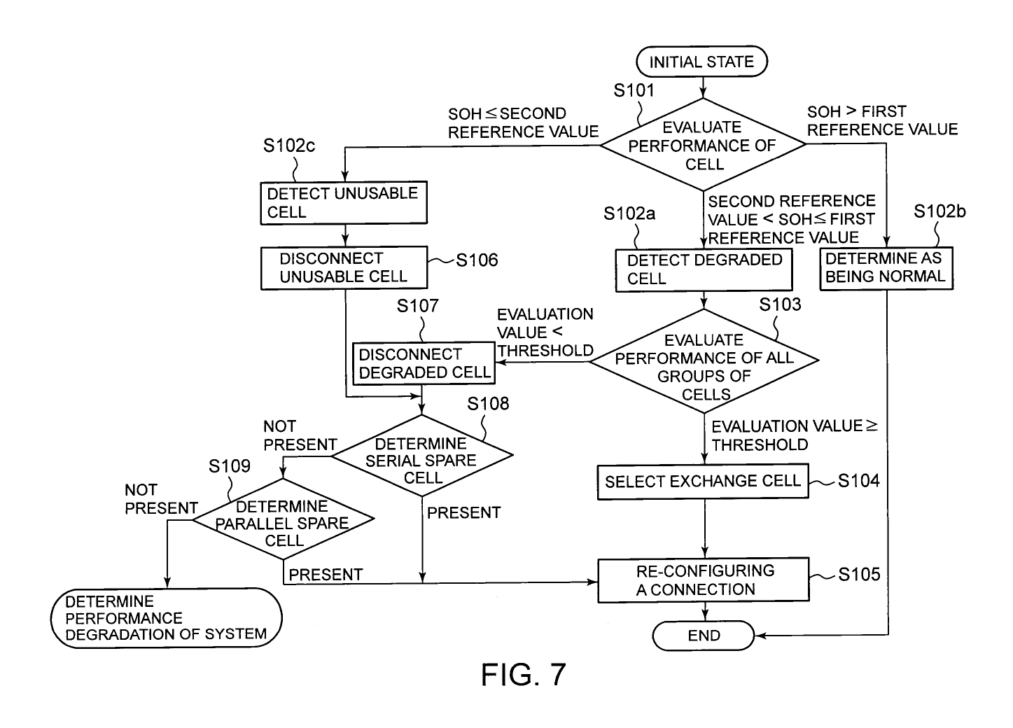

Hereinafter, a method of re-configuring a connection of battery cells 10 will be described with reference to FIG. 7.

In step S102c, when there is a battery cell 10 of which the SOH is less than or equal to a second reference value, a control unit 54 disconnects the unusable battery cell 10 in step S106.

In step S108, when there is the serial spare battery cell of which the SOH is equal to or larger than a predetermined threshold, the control unit 54 controls a serial selector 13 so as to exchange the serial spare battery cell 11 with the unusable battery cell 10. On the other hand, when the serial spare battery cell 11 of which the SOH is equal to or larger than the predetermined threshold is not present, the control unit 54 controls the parallel selector 14 so as to exchange the parallel spare battery cell 12 with the unusable battery cell 10 when the parallel spare battery cell 12 of which the SOH is equal to or larger than the predetermined threshold is present in step S109. When the parallel spare battery cell 12 of which the SOH is equal to or larger than the predetermined threshold is not present, it is determined that the performance of the storage battery system 200 has been degraded and the flows end.

Also, in step S103, when the connection of the selector 40 where the evaluation values of all battery-cell arrays become equal to or larger than the threshold is not present, the control unit 54 disconnects the degraded battery cell in step S107.

In step S108, when the serial spare battery cell 11 of which the SOH is equal to or larger than the predetermined threshold is present, the control unit 54 controls the serial selector 13 so as to exchange the serial spare battery cell 11 with the degraded battery cell 10. On the other hand, when the serial spare battery cell of which the SOH is equal to or larger than the predetermined threshold is not present, the control unit 54 controls the parallel selector 14 so as to exchange the parallel spare battery cell 12 with the degraded battery cell 10 when the parallel spare battery cell 12 of which the SOH is equal to or larger than the predetermined threshold is present in step S109. When the parallel spare battery cell 12 of which the SOH is equal to or larger than the predetermined threshold is not present, it is determined that the performance of the storage battery system 200 has been degraded and the flows end.

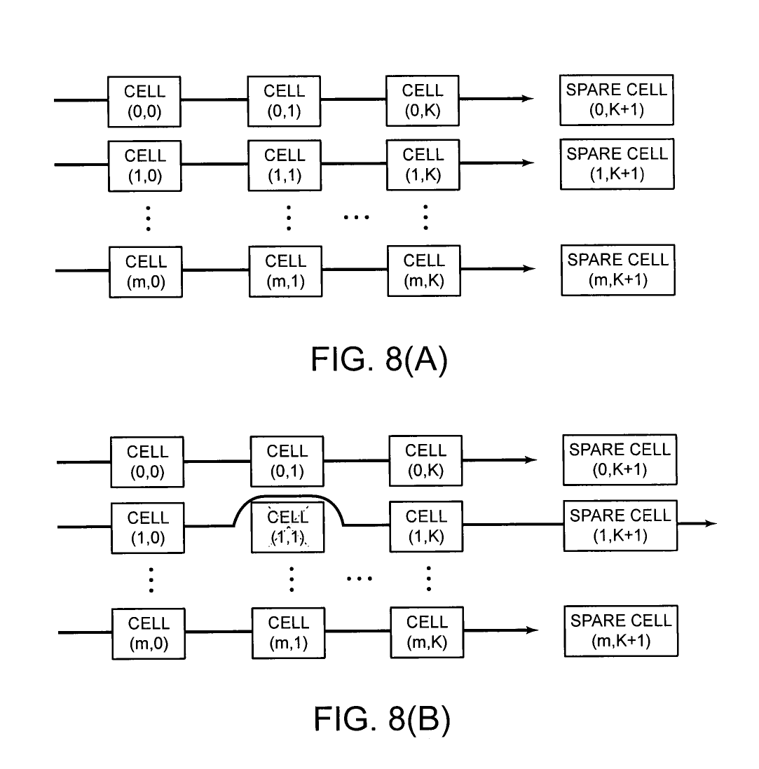

An example where the connection of the battery cell 10 has changed will be described with reference to FIGS. 8A and 8B.

FIG. 8A is in an initial normal state and battery cells 10 are serially connected to each other. Also, FIG. 8B is in a state after the connection configuration of the battery cells 10 has changed. At this time, the battery cell 10 represented by the mark × is in a state that it has been determined that the battery cell has reached the end of its lifespan. In this configuration, a spare battery cell is connected thereto in the state of bypassing the unusable cell that has been determined as reaching the end of its lifespan.

In addition, in this embodiment, a description has been made that the spare battery cell includes the serial spare battery cell 11 and the second spare battery cell 12, but the spare battery cell may include any one of the serial spare battery cell 11 and the second spare battery cell 12.

According to the storage battery system or the method of re-configuring a connection of at least one of embodiments described above, the capacity degradation of the storage battery system can be suppressed and the lifespan thereof can become long.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the sprit of the inventions. The accompanying claims and their equivalents are intended to cover such forms or modifications as would fall within the scope and spirit of the inventions.

What is claimed is:

1. A storage battery system, comprising:
a group of battery cells that includes a plurality of battery-cell arrays in which a plurality of battery cells are serially connected to each other, and the plurality of battery-cell arrays are connected to each other in parallel;
a first connection unit that exchangeably connects different battery cells that are included in the different battery-cell array of the group of battery cells;
an estimating unit that estimates a degraded state of the plurality of battery cells;
a determining unit that compares the degraded state of the plurality of battery cells estimated by the estimating unit with a first predetermined degraded state, to determine whether to exchange the battery cell;
a calculating unit that calculates an evaluation value to evaluate a health state of the plurality of battery-cell arrays based on the degraded state of the plurality of battery cells estimated by the estimating unit; and
a control unit that controls the first connection unit connected to a degraded battery cell which is determined that exchange is needed by the determining unit, so as to exchange the degraded battery cell with a battery cell different from the degraded battery cell in a direction where the evaluation value becomes equal to or larger than a predetermined threshold.

2. The storage battery system according to claim 1,
wherein the estimating unit estimates a state of health (SOH) of the plurality of battery cells, and
when the SOH estimated by the estimating unit is smaller than or equal to a first reference value representing the first degraded state, the determining unit determines that there is a need to exchange the battery cell.

3. The storage battery system according to claim 1, further comprising:
a spare battery cell; and
a second connection unit that exchangeably connects the spare battery cell to the battery cell,
wherein the determining unit compares the degraded state of the plurality of battery cells estimated by the estimating unit with a second predetermined degraded state representing a state degraded more than the first degraded state, to determine the lifespan of the plurality of battery cells, and
the control unit controls the second connection unit so as to exchange the battery cell determined as reaching the end of its lifespan by the determining unit with the spare battery cell.

4. The storage battery system according to claim 3,
wherein the estimating unit estimates the SOH of the plurality of battery cells, and
the determining unit determines that there is a need to exchange the battery cell when the SOH of the battery cell estimated by the estimating unit is smaller than or equal to a first reference value representing the first degraded state, and determines that the battery cell reaches the end of its lifespan when the SOH of the battery cell estimated by the estimating unit is smaller than or equal to a second reference value representing the second degraded state.

5. A method of re-configuring a connection in a storage battery system including a group of battery cells that includes a plurality of battery-cell arrays in which a plurality of battery cells are serially connected to each other, and the plurality of the battery-cell arrays are connected to each other in parallel, and a first connection unit that exchangeably connects different battery cells that are included in the different battery-cell array in the group of battery cells, the method comprising:
estimating, by an estimating unit, a degraded state of the plurality of the battery cells;
comparing, by a determining unit, the degraded state of the plurality of battery cells estimated by the estimating unit with a first predetermined degraded state to determine whether to exchange the battery cell;
calculating, by a calculating unit, an evaluation value to evaluate a health state of the plurality of battery-cell arrays based on the degraded state of the plurality of battery cells estimated by the estimating unit; and
controlling, by a control unit, the first connection unit connected to a degraded battery cell which is determined that exchange is needed by the determining unit, so as to exchange the degraded battery cell with a battery cell different from the degraded battery cell in a direction where the evaluation value becomes equal to or larger than a predetermined threshold.

6. The method according to claim 5,
wherein the step of the estimating unit estimates a state of health (SOH) of the plurality of battery cells, and
when the SOH of the battery cell estimated by the estimating unit is smaller than or equal to a first reference value representing the first degraded state, the step of the determining unit determines that there is a need to exchange the battery cell.

7. The method according to claim 5,
wherein a second connection unit exchangeably connects a spare battery cell to the battery cell, and
wherein the step of the determining unit compares the degraded state of the plurality of battery cells estimated by the estimating unit with a second predetermined degraded state representing a state degraded more than the first degraded state, to determine the lifespan of the plurality of battery cells, and
the step of the control unit controls the second connection unit so as to exchange the battery cell determined as reaching the end of its lifespan by the determining unit with the spare battery cell.

8. The method according to claim 7,
wherein the step of the estimating unit estimates the SOH of the plurality of battery cells, and
the step of the determining unit determines that there is a need to exchange the battery cell when the SOH of the battery cell estimated by the estimating unit is smaller than or equal to a first reference value representing the first degraded state, and determines that the battery cell reaches the end of its lifespan when the SOH of the battery cell estimated by the estimating unit is smaller than or equal to a second reference value representing the second degraded state.
